(19) United States
(12) Patent Application Publication
(10) Pub. No.: US 2009/0003225 A1
(43) Pub. Date: Jan. 1, 2009

(54) METHOD AND APPARATUS FOR PROBING OF A COMMUNICATION NETWORK

(75) Inventors: Fredrick Klassen, Coquitlam (CA); Clayton Matthew Nobbs, Coquitlam (CA); Loki Michael Jorgenson, Vancouver (CA)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: Apparent Networks, Inc., Wellesley Hills, MA (US)

(21) Appl. No.: 12/133,311

(22) Filed: Jun. 4, 2008

Related U.S. Application Data
(60) Provisional application No. 60/941,854, filed on Jun. 4, 2007.

(51) Int. Cl. G06F 11/30

(52) U.S. Cl. 370/250

(57) ABSTRACT

The test packet sequencer according to the present invention, is configured to generate one or more sequences of packets and subsequently place these one or more sequences of packets onto a communication network. The test packet sequencer is further configured to measure timings associated with the one or more sequences of packets. For example, the test packet sequencer can be configured to measure the departure and/or receipt times of one or more sequences of packets. In order to overcome inherent delays or inaccuracies relating to the functionality of one or more components along the network path, the test packet sequencer is configured to pre-activate at least a portion of the network path prior to placement of the one or more sequences of packets on the communication network.

### CROSS-REFERENCE TO RELATED APPLICATIONS

This application claims priority to and expressly incorporates by reference herein the entirety of U.S. Provisional Application No. 60/941,854, filed Jun. 4, 2007 for all purposes.

### FIELD OF THE INVENTION

### Background

The performance of an Internet Protocol (IP) network is measured by the data transfer capacity or “bandwidth,” reliability with which it can transfer packets of information from one location on the network to another, and the delay or latency involved in such transfers. A typical IP network comprises a number of packet handling devices which are interconnected by data links. The packet handling devices may include routers, switches, bridges and the like. The data links may include various transmission media such as optical fibres, wireless connections, wired connections, connections over telephone lines, and the like.

The operation of a computer network depends upon many interacting factors including the ways in which different packet handling devices on the network are configured, the types of data links, usage of links in the network, and so on. Defects or misconfigurations of individual network components can have severe effects on the performance of the network. Currently, the increasing complexity and decreased visibility in communication networks coupled with a continued trend towards network-dependent applications and services creates a need for rapid, low-effort assessment of networks.

There exist various methods for measuring network performance and identifying causes for substandard network performance. Some of these methods include sending packets, or bursts of packets, along one or more paths through the network. Information regarding the network's performance can be obtained by observing characteristics of the packets as they propagate through the network. In particular, the ability to characterize the performance and nature of an end-to-end network path based on its response to, for example, a limited number of packets transmitted between two end-hosts, provides an economical means of assessing the network on-demand with little or no overhead.

One example of network analysis software which uses test packets to measure network performance is a software utility called “pchar”. Pchar operates on computers running the UNIX operating system and obtains measures of the data transfer capacity, latency, and loss of links along an end-to-end path through a network by monitoring the dispersion of test packets as they propagate through the network. Pchar however can be of limited use for testing high capacity networks because it can place packets onto a network only relatively slowly. Pchar uses standard application programming interfaces (APIs) to control a network card to place packets onto a network which results in relatively wide spacing of the test packets.

In addition, a further disadvantage of such a system is that since the packet time-stamping occurs at the application software, the propagation times through the software stacks are included in, for example, the round trip time of a test packet determined in this manner. The propagation times through the software stacks are subject to non-deterministic delays induced by operating systems and software processes. These delays are typically non-deterministic because the operating systems and software processes are typically multitasking, and thus dependent on instantaneous loading from various external factors.

There also exist hardware-based network traffic generators which are capable of placing packets onto a network. Such traffic generators typically comprise specialized hardware configurations which may reduce errors introduced by solely using software. These traffic generators however, are typically expensive and hardware specific.

An example of such a specialized hardware device is disclosed in U.S. Pat. No. 7,058,020 wherein a system for time-stamping a data packet associated with a data network allows software applications, running on non-deterministic systems, to determine the precise time that packets were transmitted to or received from a physical network interface. The system includes a network media interface device for transferring a data packet to or from a network medium, and a time source for generating and maintaining a time code. The system further includes a specialized time-stamping circuit for sampling a time code from the time source when the interface device transfers the data packet to or from the network medium, and for associating the time code with the received data packet so as to form a time-stamped packet.

It is known that precision handling of IP packets can be difficult to achieve in software, and particularly when executed on commodity hardware that has not been modified as suggested above, through the use of speciality hardware. Due to the costs associated with specifically modified hardware, techniques are desired to overcome issues relating to a software implementation.

United States Patent Application Publication No. 20030117959 discloses an example of a software implementation, wherein a test packet sequencer for dispatching test packets onto a computer network comprises a computer running software under an operating system, wherein this test packet sequencer is also configured to enable more precise measurement of test packet departure and receipt timings. The software uses I/O completion ports to dispatch packets and bursts of packets. The packets may be dispatched to travel a path in the network which terminates at the test packet sequencer. The software may also receive and time-stamp the receipt of packets and bursts of packets. The test packet sequencer may receive the packets in I/O completion ports and the software may have a test handler thread which terminates its current time slice just prior to sending a burst of packets so that the packets are all dispatched within a single time slice of the test handler thread. This software implementation however may be considered to be applicable to a particular operating system (OS) namely Microsoft™ Windows™ OS or other OS which has a similar completion port configuration.

While the above discusses a number of examples of mechanisms that can place test packets onto a communication network, these mechanisms are typically located at the source of the test packets and are involved with the initial placement of the test packets onto the communication network in addition to the reduction of delays associated with the departure timings and receipt timings being collected. However, as discussed above these mechanisms can be hardware-specific, expensive or OS-specific, and therefore are not applicable for a general computing platform. Furthermore, there are additionally instances of non-deterministic delays that can be inherently included within collected timings, wherein these additional instances can be associated with the intermediate network path itself, namely the portion of the network path subsequent to the mechanism configured as the source of the test packets.

Therefore there exists a need for an apparatus and methods for efficiently transmitting and receiving packets via a communication network that may provide mitigation of delays associated with network components along a network path. There is also a need for such an apparatus and methods which can be implemented substantially independent of a computing devices operating system, without a requirement for typically expensive specialized hardware.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the invention is to provide a method and apparatus for probing of a communication network. In accordance with an aspect of the invention, there is provided a method for probing at least a portion of a communication network, the method comprising: generating one or more sequences of packets; performing a pre-activation action on at least a portion of a network path defined within the communication network; dispatching the one or more sequences of packets onto the communication network, the one or more sequences of packets configured to travel along at least a portion of the network path; and measuring timings associated with the one or more sequences of packets.

In accordance with another aspect of the invention, there is provided an apparatus for probing at least a portion of a communication network, the apparatus comprising: means for generating one or more sequences of packets; means for performing a pre-activation action on at least a portion of a network path defined within the communication network; means for dispatching the one or more sequences of packets onto the communication network, the one or more sequences of packets configured to travel along at least a portion of the network path; and means for measuring timings associated with the one or more sequences of packets.

In accordance with another aspect of the invention, there is provided an apparatus for probing at least a portion of a communication network, the apparatus comprising: a computer processor; a network interface operatively coupled to the computer processor; a memory accessible by the computer processor, the memory comprising test packet sequencer software comprising a series of instructions executable by the computer processor under control of an operating system, the instructions, if executed by the computer processor, causing the computer processor to: generate one or more sequences of packets; perform a pre-activation action on at least a portion of a network path defined within the communication network; dispatch the one or more sequences of packets onto the communication network using the network interface, the one or more sequences of packets configured to travel along at least a portion of the network path; and measuring timings associated with the one or more sequences of packets.

In accordance with another aspect of the invention, there is provided a computer program product comprising a computer readable medium having a computer program recorded thereon which, when executed by a computer processor, cause the processor to execute a method for probing at least a portion of a communication network, said method comprising the steps of: generating one or more sequences of packets; performing a pre-activation action on at least a portion of a network path defined within the communication network; dispatching the one or more sequences of packets onto the communication network, the one or more sequences of packets configured to travel along at least a portion of the network path; and measuring timings associated with the one or more sequences of packets.

### BRIEF DESCRIPTION OF THE FIGURES

FIG. 1 is a schematic view of an example path through a network from a first location to a second location.

FIG. 2 illustrates a test packet sequencer according to an embodiment of the invention.

FIG. 3 illustrates an example of a sequence of packets configured as a burst of test packets.

FIG. 4 illustrates an example of a primer packet being transmitted prior to a sequence of packets according to an embodiment of the invention.

FIG. 5A illustrates a method for probing a portion of a communication network according to an embodiment of the present invention.

FIG. 5B illustrates a method for probing a portion of a communication network according to another embodiment of the present invention.

### DETAILED DESCRIPTION OF THE INVENTION

### Definitions

The term “sequence of packets” is used to define a datagram, a burst, a stream or the like. For example, a datagram is a single packet transmitted with large inter-packet separations in time relative to other datagrams. A burst is a group of packets transmitted with small inter-packet spacing, wherein bursts are transmitted with large inter-burst separations. A stream is a sequence of bursts or datagrams transmitted with a separation between the bursts or datagrams, which may be a fixed separation or may be a separation defined by a mathematical or statistical function, or may be a separation according to external trigger events.

The term “source host” is used to define the location or node of a network from which transmission of the one or more sequences of packets for probing the network path originate.

The term “destination host” is used to define the location or node of a network that defines an end-to-end path with regard to a specific source host.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

When analysis of packet timings is used to evaluate the operational characteristics of a network path, precision relating to the time of transmission and the time of reception of each packet can be important. A delay in the response of the transmitting or source host, receiving or destination host, or any intervening network element along a network path being evaluated may introduce variations in packet timings that are not reflective of the typical response of the network path. For example, artefacts may be introduced in the packet timings that reflect the influence of the operating system, particularly on the source host or the destination host at either end of the network path. In addition, when a time variation effect having a small amplitude is present in a network path, a delay in the response of source host, destination host, or any intervening network element may obscure this small amplitude effect. Thus precision of time measurements is desired. In addition, this desired precision of time measurements can become even more important as the transfer capacity of a network increases.

Preferably, all devices and interfaces on a selected end-to-end network path, which may be defined (for example for a given network) by two IP addresses for example that of the source host and the destination host, are appropriately prepared to respond as quickly as possible to any transmitted packets. For example, the minimum response time for the transmission of a packet can represent a baseline from which all time-variant influences on the operation of the network path manifest their effects. There are a wide range of different time-variant effects, some of which are representative of typical network performance and others that may affect packet transmission, forwarding, or reception.

A test packet sequencer according to the present invention may be implemented in a computing device which operates under an operating system (OS), wherein the configuration of the test packet sequencer is independent of a specific OS for operation thereof. In addition, the test packet sequencer is configured to be operable on generic hardware and thus can provide a desired level of functional accuracy without the need for specialized hardware. The test packet sequencer generates one or more sequences of packets which may be one or a combination of individual packets, bursts of packets, streams of packets or the like, and places these one or more sequences of packets onto a data communication network to which the computing device is connected.

A test packet sequencer can measure timings associated with the one or more sequences of packets. For example a test packet sequencer can measure one or both of departure and receipt times of individual test packets of the one or more sequences of packets, which for example can include time-stamping departure and arrival times. In embodiments of the invention, the test packet sequencer can automatically measure departure and/or receipt times of the one or more sequences of packets which traverse an entire network path traveled along the communication network, as well as for one or more sequences of packets which traverse portions of the network path which can end at locations along the network path, for example at an intermediate network device along the network path. The type of timing measurements performed by a specific test packet sequencer can be based on the configuration of the network path being probed. For example, in a closed network path or closed loop, the same test packet sequencer can perform time stamping of both the departure and receipt of the one or more sequences of packets. In another example, wherein the network path is an open path or one-way path, a first test packet sequencer can be configured to time stamp the departure of the one or more sequences of packets and another test packet sequencer can be configured to time stamp the receipt of the one or more sequences of packets.

The test packet sequencer according to the invention, is configured to generate one or more sequences of packets and subsequently place these one or more sequences of packets onto a communication network. The test packet sequencer is further configured to at least measure the departure times of the one or more sequences of packets and in some embodiments the same test packet sequencer is further configured to measure receipt times of one or more sequences of packets. In order to overcome inherent delays or inaccuracies relating to the functionality of one or more components along the network path, and thus the precision of the timings of the transmission and reception of the one or more sequences of packets, the test packet sequencer is configured to pre-activate at least a portion of the network path prior to placement of the one or more sequences of packets on the communication network. This pre-activation action performed on at least a portion of the network path can enable the reduction of inherent non-deterministic and mechanical delays associated with one or more of operating systems, software processes, network devices or the like associated with the network path. For example, a pre-activation action may optimize the response of one or more devices along the network path by overcoming delays that may be introduced by idling, allocation overhead or other condition of “inattention” of a device along the network which may result from a polling- or interrupt-based general purpose hardware architecture. Similarly, a pre-activation action may establish a state within a device along the network path that is representative of a known condition, such as that associated with a network under heavy load, or that may compensate for other known deficiencies relating to the use of an active probing methodology.

In one embodiment of the invention, the pre-activation action comprises the transmission of one or more primer packets, prior to the placement of the one or more sequences of packets onto the communication network, wherein the one or more primer packets are independent of the one or more sequences of packets. The transmission of one or more primer packets prior to the transmission of the one or more sequences of packets can prepare the interfaces of devices along the network path for reception and subsequent re-transmission of the one or more sequences of packets. In this manner, the priority of the actions relating to packet handling of the devices along the network path are effectively prepared just prior to the transmission of the one or more sequences of packets, thereby reducing delays which may result from “idle” interfaces, for example.

In another embodiment of the invention, the pre-activation action comprises component warming which can enable the preparation of the computing device which is to transmit the one or more sequences of packets, namely the source host, for the task of packet transmission. For example, the pre-activation action can comprise the transfer of the one or more sequences of packets to be transferred into a cache memory, which is most easily accessed by the central processing unit of the computing device. A pre-activation action of this type may additionally or alternately include transferring the one or more instructions to be used for the transmission of the one or more sequences of packets into cache memory, wherein example instructions can include routines used to send and time stamp the one or more sequences of packets. In this manner, delays associated with the rate of access to the required information can be mitigated thereby reducing inherent delays that may occur at the source host.

In another embodiment of the invention, a desired pre-activation action is subsumed or a resultant effect of another action or mechanism which is primarily intended for a different purpose. A pre-activation action of this type can be considered to be a by-product of this other action or mechanism. For example, if a desired pre-activation action is cache warming of a destination host or intervening node or data link between the source host and the destination host, through the establishment of an out-of-band Transmission Control Protocol (TCP) connection with a request for spurious information, for example SNMP (Simple Network Management Protocol), the desired pre-activation action of cache warming is a resulting by-product of this request. In addition, for example if a primary pre-activation action is desired, the mechanism selected for performing this primary pre-activation action may additionally result in a by-product pre-activation action occurring. In this manner, multiple desired pre-activation actions may be enabled by a single selected action or mechanism.

### Communication Network and Transmission of Test Packets

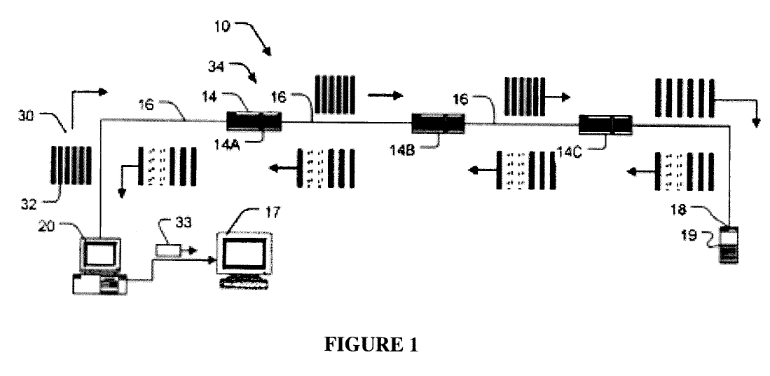

FIG. 1 illustrates an example of a portion of a network 10, wherein a portion of the network can be defined as a network path. The network comprises an arrangement of network devices 14 interconnected by data links 16. The network devices may comprise, for example, routers, switches, bridges, hubs, gateways and the like and the data links may comprise physical media segments such as electrical cables, fibre optic cables, or the like or transmission type media such as radio links, laser links, ultrasonic links, or the like. In addition an analysis system 17 can be connected to the network 10.

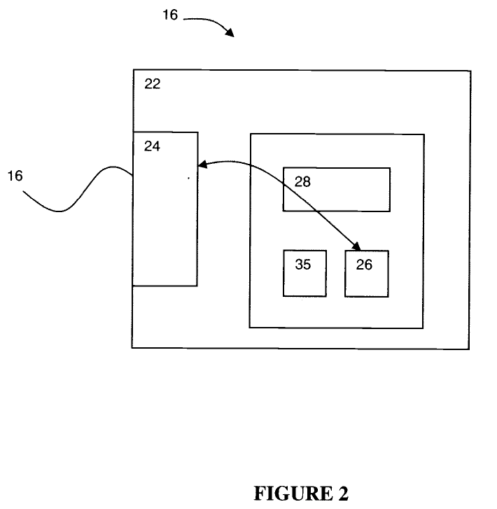

A test packet sequencer 20 is located at a source host and is connected to network 14 wherein an embodiment of a test packet sequencer is illustrated in FIG. 2. Test packet sequencer 20 comprises a source host computing device 22, for example a computer, which includes a network interface 24 and runs test packet sequencer software 26 under an operating system 28. Operating system 28 may be a version of the Microsoft™ Windows™ operating system such as Microsoft Windows 2000™, XP™, Vista™ or the like or Mac OS™, Mac OS X™ or the like, or UNIX™, HP-UX, AIX, Solaris, Linux, or other OS as would be readily understood by a worker skilled in the art.

In the example as illustrated in FIG. 1, network path 34 is a closed loop, wherein one or more sequences of packets originate at a test packet sequencer 20, travel along the network path 34 to a reflection point 18 located at the destination host 19, and then propagate back to the test packet sequencer 20. The network path, however, does not need to be a closed loop, for example, the mechanism for dispatching the test packets may be separated from the mechanism that receives the test packets after they have traversed the network path.

For example when the network path is a closed loop, one way to use test packet sequencer 20 is to generate one or more sequences of packets, send those test packets on network 14 to a destination, such as a destination host 19, and measure and record the times at which each of the test packets is dispatched from test packet sequencer 20 and received back at test packet sequencer 20. Alternately, wherein the network path is a one way, or open path, a first mechanism, for example a test packet sequencer, can be positioned at the source host in order to dispatch one or more sequences of packets and a second mechanism, for example a second test packet sequencer, can be positioned at the destination host, and can be used to receive the one or more sequences of packets. In this configuration, the first and second mechanisms would measure and record times related to the departure and receipt, respectively, of the one or more sequences of packets.

In one embodiment of the invention, these one or more sequences of packets which are transmitted can be a datagram, tight datagram, burst, burstload, stream or the like as would be readily understood by a worker skilled in the art. A datagram is a single packet with a large inter-packet separation in time relative to a subsequent datagram, for example the separation between the single packets can be in the range of hundreds of milliseconds on an Ethernet communication network. In addition, a tight datagram is a single packet with a relatively small inter-packet separation in time relative to a subsequent datagram, for example the inter-packet spacing measured from the beginning of one packet header to the next packet header can be on the order of about 10 milliseconds on a 10 Mbps Ethernet communication network. A burst is a group of packets, wherein the separation between these packets close to the minimum which is possible. The inter-burst separation in time is relatively large and can be in the range of hundreds of milliseconds on an Ethernet communication network. Furthermore, a burstload is an extended burst of many packets back-to-back, which can typically be more than an order of magnitude larger than a burst. For example, a burstload can comprise in the order of hundreds of packets. Finally, a stream is a sequence of bursts or a sequence of datagrams, which for example can have a fixed separation of time therebetween, a separation defined by a mathematical or statistical function, or a separation defined according to external trigger events or the like. Each of these sequences of packets can be used to actively sample or probe a network path in order to collect information representative of its end-to-end performance. The above is a non-limiting list of formats used for the one or more sequence of packets. It is within the scope of the invention that the format of one or more sequences of packets can additionally be an arbitrary combination of packets configured, for example using varying packet sizes, packet protocol, inter-packet spacing and the like.

In one embodiment, and based on the above, the inter-packet spacing for one or more sequences of packets can be also be classified as substantially independent, quasi-independent, dependent and substantially contiguous or the like. This classification can be reflective of the likelihood that an initial packet in a sequence is encountered by a subsequent packet in the sequence of packets. For example, in a queue or transmission line, packets can be considered to encounter each other if they are substantially adjacent in the queue or transmission line. For example, the inter-packet spacing between datagrams can be considered to be substantially independent. The inter-packet spacings between tight datagrams or streams can be considered to be quasi-independent and the inter-packet spacing between packets which form a burst or a burstload can be considered to be dependent and substantially contiguous.

In one embodiment, the inter-packet spacing between packets can be considered to be substantially independent in that the transmission of a first packet does not substantially affect the transmission of a second, later transmitted packet, since processing delays for the second packet cannot be strongly attributed to processing of the first packet. For example, if the first packet is processed a sufficiently large amount of time before the second packet, then events of substantial impact can occur in the intervening time, such as processor idling, empty or full queue events, or processing of other packets or tasks requiring a variable amount of time and/or resources. These intervening events tend to degrade the causal link between processing of the first packet and delay of the second packet, thereby making it increasingly difficult to attribute processing delays for the second packet to processing of the first packet. Similarly, in one embodiment, the inter-packet spacing between packets can be considered to be dependent in that the transmission of the first packet substantially affects the transmission of the second, later transmitted packet, since processing delays for the second packet can be strongly attributed to processing of the first packet. For example, if the first packet closely (or immediately) precedes the second packet, the second packet can have a substantially fixed spacing from the first packet since processing of the first packet is typically completed before processing of the second packet in a FIFO system.

Other factors, such as priority queuing systems, multiple available packet routes, and number and type of packet flows through a network can affect the inter-packet spacing and classification thereof, as would be understood by a worker skilled in the art. In one embodiment of the present invention, such factors are accounted for when configuring transmission of packets.

Furthermore as would be readily understood by a worker skilled in the art, as the transfer capacity of a communication network increases, for example from Mbps to for example Gbps, the spacings as defined above can decrease accordingly. Thus the above description of example sequences of packets is intended as an example only and is not to be considered as limiting.

With further reference to the example of a portion of a network as illustrated in FIG. 1, the test packet sequencer 20 that dispatches one or more sequences of packets 30 each comprising one or more test packets 32 is connected to the network 14. The network path 34 extends from the test packet sequencer 20 through routers 14A, 14B, and 14C to a destination host 19 from where the packets are routed back through routers 14C, 14B, and 14A to return to test packet sequencer 20. There are various ways to cause test packets 32 to traverse a network path 34. For example, the test packets 32 may comprise Internet Control Message Protocol (ICMP) ECHO packets directed to destination host 19 which will automatically generate an ICMP ECHO REPLY packet in response to each ICMP ECHO packet or alternately an ICMP ECHO packet may result in an ICMP TTL Expiry packet being created in response at some mid-path network device. For another example, test packets 32 could be another type of packet protocol, such as packets formatted according to the Transmission Control Protocol (TCP) or User Datagram Protocol (UDP) wherein packets of these protocols are port specific and may generate a ICMP Port Unreachable packet from a destination host or an ICMP TTL Expiry packet from a mid-path device, for example. Such packets could be sent to destination host 19 and then returned to test packet sequencer 20 by software or hardware at destination host 19, for example UDP echo daemon software, in the form of a UDP ECHO packet. In addition, in embodiments of the present invention, test packets can be configured using Real-time Transport Protocol (RTP).

Furthermore, as would be known to worker skilled in the art, protocols for the transmission of packets on a communication network are constantly evolving, for example the introduction of IPv6. It is readily understood that the configuration of the one or more sequences of packets can be based on a currently available protocol, for example ICMPv6, or other communication protocol as would be readily understood. In addition, according to embodiments of the invention, the one or more sequences of packets can additionally be configured based on network communication protocols that can be used for multicast transmission, broadcast transmission or the like.

The one or more sequences of packets being sent along a network path can be of varying sizes, wherein each packet of a given sequence is of fixed size but each sequence is of differing size, or where each packet within a sequence may be of a different size. The packet sizes may vary from the smallest packet possible to the largest size of a packet as defined by the maximum transmission unit (MTU) supported by the network path to the selected destination host. For example, if a packet larger than the MTU is transmitted, the packet will either be fragmented into smaller packets at the point in the network that defines the MTU, or it will be discarded, wherein a fragmentation response will typically be received by the test packet sequencer 20 indicating what maximum size is allowable.

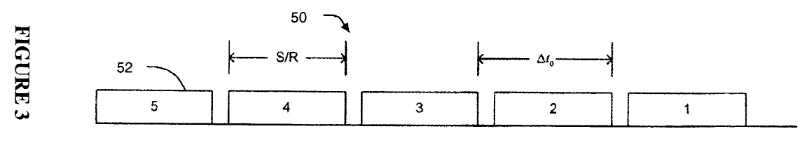

With reference to FIG. 1, in one embodiment of the invention test packet sequencer 20 generates one or more sequences of packets which are configured as bursts 30 of test packets 32. FIG. 3 illustrates a burst of test packets configured according to an embodiment of the invention, wherein each packet 52 in a burst 50 has a size S. For example, in an Ethernet network, S is typically in the range of about 46 bytes to about 1500 bytes. The packets in burst 50 are dispatched in sequence. Each packet is completely dispatched in a time S/R where R is a rate at which the data of the packet is placed onto the network. Two packets 52 at the ends of sequentially adjacent bursts 50 are separated by an interval Δt₀. In many cases it is desirable that the packets in a burst 52 be very closely spaced, in order that Δt₀ is about equal to S/R. In general, S and Δt₀ do not need to be constant for all packets 52 in a burst 50 although it can be convenient to make S and Δt₀ about the same for all packets 52 in each burst 50.

With further reference to FIG. 1, as packets 32 pass along network path 34 through network devices 14 and data links 16, individual packets 32 may be delayed by different amounts and some packets 32 may be lost in transit. Packet losses can occur due to various circumstances such as addressing errors, network device errors, routing issues, excessive hop counts, buffer overflows, or active queue management systems operating on network devices such as routers. Various characteristics of the network devices 14 and data links 16 along network path 34 can be determined by observing how the transmission characteristic data derived from departure and receipt times of different packets in the one or more sequences of packets varies. This transmission characteristic data can include measures relating to latency, delay variation, packet loss among others, for example.

An analysis system 17 can receive the test data 33, wherein the analysis system may comprise a programmed computer. Analysis system 17 may be hosted in a common device or located at a common location with test packet sequencer 20 or may be separate therefrom. As long as analysis system 17 can receive test data 33, its precise location is a matter of convenience. For example, the analysis system can process the test data to obtain reduced test data and this reduced test data can comprise statistical information derived from the test data, wherein this reduced test data can be used to obtain test result information. The test result information may include estimates for network parameters including for example, maximum available data transfer rates of various data links along the network path, utilization of various data links along the network path, jitter, propagation delay, queue depth and/or other network performance indicators as would be readily understood by a worker skilled in the art. In addition test result information may indicate the presence of various network problems or conditions, for example duplex mismatch, media errors, congestion, MTU conflicts, intermittent connectivity, collision domain violation, rate limiting queue, firewall limiting, router loops, header congestion, or other network problems as would be readily understood by a worker skilled in the art.

In one embodiment of the invention, the test packet sequencer uses a high resolution hardware counter for time-stamping which can be associated with the CPU chip. The hardware counter can provide high time resolution, which is based on an internal clock with a specific frequency. For example, if a CPU chip is configured with a 3 GHz processor, a hardware counter based on the CPU chip clock can measure events that last at least several nanoseconds with accuracy in the range of nanoseconds.

In another embodiment of the present invention, the test packet sequencer comprises an independent time-stamping circuit specifically designed for the time-stamping of test packets at transmission and/or receipt.

### Pre-Activation Action

As previously discussed, in order to overcome inherent delays or inaccuracies relating to the functionality of one or more components along the network path, and thus to increase the precision of the timings of the transmission and receipt of the one or more sequences of packets, the test packet sequencer is configured to pre-activate at least a portion of the network path prior to placement of the one or more sequences of packets on the communication network. This pre-activation action performed on at least a portion of the network path can enable the reduction of inherent non-deterministic delays associated with one or more of operating systems, software processes, network devices, CPU hardware or the like associated with the network path. For example, a pre-activation action may optimize the response of one or more devices along the network path by overcoming delays that may be introduced by idling, allocation overhead or other condition of “inattention” of a device along the network which may result from a polling- or interrupt-based general purpose hardware architecture.

For example, possible inherent delays along at least a portion of a network path can include but are not limited to: 1) idle interfaces, for example interfaces of one or more network devices along the path may be inactive or dormant; 2) a idle or distracted operating system, for example an operating system associated with the source host or the destination host may be idle or performing other tasks; 3) limiting mechanisms along the network path, for example limiting mechanisms can include byte limiting mechanisms which limit the bytes-per-second or number-limiting mechanisms which limit the packets-per-second; 4) multi-channel paths, for example along a multi-channel path resource allocation mechanisms can reserve a portion of the data transfer capacity of the network path until required, wherein a minimum path capacity is assigned until the resource allocation mechanism detects that a higher capacity is required; 5) Anti-DDOS (distributed denial of service) devices, for example this format of device can impede probing of the network path by reducing capacity of the network path; and 6) bad buffer memory, for example a network device along the network includes some buffer memory which is defective. Other inherent delays which can be associated with a network path would be readily understood by a worker skilled in the art.

For each of the above examples of an inherent delay along a network path, a pre-activation action can be associated therewith in order to identify and/or overcome the inherent delay in the transmission of one or more sequences of packets. One or more pre-activation actions may be performed in order to overcome one or more of the identified inherent delays, and in addition, one or more different pre-activation actions can be performed with respect to the same network path prior to the transmission of one or more sequences of packets. For example: 1) An idle interface may be “woken” up by transmitting a primer packet along a portion of the network path prior to the transmission of the one or more sequences of packets to be timed; 2) An idle or distracted operating system may be “woken up or pre-activated” by the pre-accessing of required cache memory and/or routines required for the transmission and/or time-stamping of the one or more sequences of packets; 3) A limiting mechanism can be identified and can be activated or avoided, for example by the configuration of the one or more sequences of packets or the transmission of one or more primer packets in order to either evaluate the impact of the limiting mechanism or to substantially limit the impact that the limiting mechanism has on the travel time of the one or more sequences of packets; 4) Multi-channel paths can be identified and by the transmission of a plurality of primer packets, namely pre-loading of the network path, can enable probing of the full capacity of the network path; 5) Anti-DDOS behaviour of a network path can be identified and through the configuration of the one or more sequences of packets or one or more primer packets, this type of mechanism can be either avoided or pre-activated in order to limit the effect thereof or enable the evaluation of the its effect; 6) If a network device along the network path comprises a bad buffer memory portion, the one or more sequences of packets can be configured or one or more primer packets can be transmitted in order to sufficiently load the buffer memory of the network device resulting in required access of the bad buffer memory portion. Other specific pre-activation actions for the above examples of inherent delays as well as other inherent delays would be readily understood by a worker skilled in the art and are considered to be within the intended scope of the present invention.

In one embodiment of the invention, the response of a communication network to a pre-activation action can be examined and/or analysed, wherein the configuration of subsequently transmitted one or more sequences of packets are modified based on this analysis of the response to the pre-activation action. For example, if a pre-activation action of sending a primer packet is performed and a response to this primer packet is not received in a predetermined time period, the subsequently transmitted one or more sequences of packets may be modified in order to sample the communication network for connectivity, for example.

### Primer Packet Transmission

The transmission of a single packet or a small grouping of packets along a network path, may result in differing levels of responsiveness from the network path when compared with a stream of packets, for example which may occur with a real-time application like video streaming, or when compared to a flood of packets, for example which may occur with file transfer. For example, when sending a single packet or group of packets, there may be a latency in the response of the devices along the network path due to one or more of the network interfaces having “gone idle” and thus require activating in order to process the packets, requiring a finite amount of time to become active. Typically, after these network interfaces have processed the first packet, subsequent packets may be handled more assiduously until a predetermined period of time has passed such that the interfaces time out and “fall idle” or change their processing priority in order to accommodate other tasks.

In one embodiment of the invention, the pre-activation action includes the transmission of one or more primer packets, prior to the placement of the one or more sequences of packets onto the communication network, wherein the one or more primer packets are independent of the one or more sequences of packets. The transmission of the one or more primer packets can prepare the interfaces of devices along the network path to be probed. Also through the transmission of the one or more primer packets, the one or more packet handling devices along the network path being evaluated will elevate the priority of the actions relating to packet handling and thus these devices can be effectively prepared just prior to the transmission of the one or more sequences of packets, thereby reducing delays which may result from the above mentioned “idle” interfaces, for example. In one embodiment of the present invention, a primer packet can be transmitted prior to the transmission of each datagram or each burst.

In one embodiment of the invention, the network path is configured as an open loop, namely a one-way path. For this configuration of the network path one or more primer packets can be transmitted along the network path not only to activate one or more of the “idle” interfaces of the network devices along the path, but to further ensure that the destination host is activated for the action of time-stamping the receipt of the one or more sequences of packets, for example.

The one or more primer packets are transmitted along the network path being evaluated such that these one or more primer packets traverse the network path sufficiently ahead of any subsequently transmitted one or more sequences of packets such that the one or more primer packets typically do not interfere with the passage of the one or more sequences of packets. As such the one or more primer packets are independent of the one or more sequences of packets. For example, the separation between the one or more primer packets and the one or more sequences of packets is selected such that the one or more primer packets and the packets of the one or more sequences of packets typically do not simultaneously occupy a queue or otherwise become immediately contiguous. However, the separation between the last packet of the one or more primer packets and the first packet of the one or more sequences of packets is selected to be sufficiently small in order to avoid having a network interface “fall idle” before the one or more sequences of packets arrive.

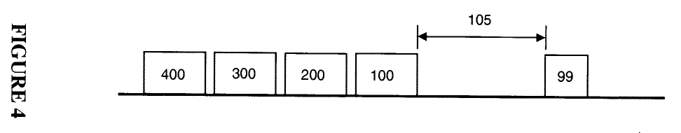

FIG. 4 illustrates an example of a single primer packet being transmitted prior to a burst of packets. The primer packet 99 is transmitted having a predetermined separation 105 between the trailing end of the primer packet and the leading end of the first test packet 100 of the burst of packets which includes test packets 100, 200, 300 and 400.

In one embodiment of the invention, the separation between the last packet of the one or more primer packets and the first packet of the one or more sequences of packets is selected such that the one or more primer packets have traversed the entire network path being evaluated prior to the transmission of the one or more sequences of packets. Therefore, the one or more primer packets have been confirmed as received by a test packet sequencer prior to the transmission of the one or more sequences of packets.

In another embodiment of the invention, the separation between the last packet of the one or more primer packets and the first packet of the one or more sequences of packets is selected such that the one or more primer packets continue to traverse the network path upon the transmission of the one or more sequences of packets. In this configuration, the one or more primer packets are “in flight” at the time of transmission of the one or more sequences of packets. For example, this selection of the separation may be required when the length of the network path being evaluated is sufficiently long that awaiting the confirmation of the receipt of the one or more primer packets, may result in a network interface timing out or falling into an idle state.

In one embodiment, window flow control or similar techniques can be used to control the separation of the primer packets and the one or more sequences of packets. For example, the one or more sequences of packets can be configured to be transmitted after all or a predetermined portion of the one or more primer packets have been acknowledged as received. As another example, the dispatching of packets in the one or more sequences of packets can be dependent on the receipt of one or more acknowledgements of primer packets or of previously dispatched packets in the one or more sequences of packets according to window flow control techniques, as would be understood by a worker skilled in the art.

In one embodiment of the invention, the trailing end of the last primer packet is separated from the leading end of the first packet of the one or more sequences of packets by between about 1 millisecond and about 10 milliseconds. In one embodiment of the invention this separation is about 5 milliseconds.

The selection of the separation time period can depend on a variety of parameters including maximum or available transfer capacity of the network, time-out delays associated with the interfaces along the network path among others, as would be readily understood by a worker skilled in the art.

In one embodiment of the invention, the separation between the trailing end of the last primer packet and the leading end of the first packet of the one or more sequences of packets is varied during a test involving the probing of a network path. For example, through the variation of the separation and evaluation of the collected timing data, the test packet sequencer can be further configured to determine a desired separation which can enable the desired network path responses to be realized, namely no packet interference or timing out of network interfaces, for example.

As there is typically a nonzero probability of interference between the one or more primer packets and the one or more sequences of packets, in one embodiment of the invention during an active probing test, sufficient statistics relating to relative packet timings between the one or more primer packets and the one or more sequences of packets are required in order to ensure a desired behaviour, namely substantially no interference of the one or more primer packets on the transmission time associated with the one or more sequences of packets. By the collection of statistics of relative packet timings, a means of identifying when interference has taken place or an analysis of these timings can compensate for the interference.

The one or more primer packets can be configured in one or more of a plurality of protocols, for example ICMP, UDP, TCP, RTP or other protocol as would be readily understood by a worker skilled in the art. In another embodiment of the invention, the one or more primer packets are configured in the same protocol as that used for the one or more sequences of packets. In another embodiment, the one or more primer packets are configured using a different protocol compared to that used for the one or more sequences of packets.

The one or more primer packets can have a size or payload which ranges between the minimum packet size supported by the communication network to the maximum transmission unit (MTU). In one embodiment, the one or more primer packets can have a size or payload which is in the range of about 46 bytes to about 1500 bytes, however smaller or larger sized primer packets may be used as supported by the network path. For example, in an embodiment of the invention the one or more primer packets have a size of about 64 bytes. In one embodiment of the invention, the one or more primer packets are configured as the same size as the one or more sequences of packets to be subsequently transmitted.

In one embodiment of the invention, the one or more primer packets are configured such that they only traverse a portion of the network path to be probed. For example, in one embodiment of the invention, the one or more primer packets are addressed to the destination host, however the one or more primer packets are configured with a TTL (Time To Live) count in their IPv4 headers which can be set to specific values in order that the one or more primer packets will expire at a specific point along the network path being probed. For example, the TTL count represents the maximum number of hops, or network devices to be traversed, and this original TTL count value is decremented upon the occurrence of each hop until this count value becomes zero. When the TTL count value becomes zero, the network device handling the packet at that time drops the packet and sends an ICMP “TTL Expired” message back to the source host indicating that the packet has been dropped. For example, a primer packet configured with a TTL=1 will expire at the first hop or network device traverse and a load configured with a TTL=2 will expire at the second hop.

In one embodiment of the invention, a test packet sequencer is configured to further validate the acceptability of collected packet timings. For example, if a single primer packet is transmitted prior to a particular sequence of packets, the test packet sequencer can be configured to validate the timings of the particular sequence of packets if there is confirmation of receipt of the primer packet transmitted before the particular sequence of packets.

In one embodiment, the acceptability of collected packet timings can be validated by comparing timings measured for one or more primer packets with timings measured for one or more test packet sequences. For example, the timings measured for the one or more primer packets can be used to establish an expected range into which the timings measured for the one or more test packet sequences can be expected to fall. If the timings measured for the one or more test packet sequences fall within the expected range, the collected packet timings can be accepted. Otherwise, if the timings measured for the one or more test packet sequences do not fall within the expected range, the collected packet timings can be rejected or a warning can be issued indicating a discrepancy.

In another embodiment of the invention, the test packet sequencer can be configured to transmit the one or more sequences of packets a predetermined period of time after the one or more primer packets. In addition, the test packet sequencer can be further configured to transmit the one or more sequences of packets upon receipt of one or more primer packets associated therewith, regardless of whether the predetermined period of time has passed.

### Component Warming

On the source host, namely the host associated with the transmitting test packet sequencer, transmission times and in some instances reception times may be affected by the time required to generate, prepare to transmit, time-stamp departure and in some cases receive and time-stamp arrival of the one or more sequences of packets. In one embodiment of the invention, a pre-activation action which is performed is component warming which can prepare the source host such that the subsequent transmission of one or more sequences of packets are substantially minimally affected by the overhead associated with the operating system and the special requirements of packet transmission, which can include time-stamping.

For example, component warming can include actions that enable memory to be allocated for a desired task, the creation of threads or threads of execution, in order for the desired task to be processed and typical reduction of wait time before shared resources are available, wherein these resources can include the central processing unit and the cache associated with a CPU.

Component warming can include the action of “touching” or “warming” the various resources needed for packet transmission by an action of preliminary access in order to substantially improve availability or readiness of these components for the subsequent transmission of the one or more sequences of packets. The various functions and resources employed by a source host during the process of packet transmission and time-stamping are candidates for warming. For example, some of these components may be generic to all operating systems and network interfaces; others may be very specific to a particular instance of a network interface card (NIC) or OS.

In one embodiment, the one or more pre-activation actions of component warming may be applied to a destination host, or node or data link, or other network device, positioned along the network path between the source host and the destination host. This may similarly affect the response of the destination host, either in reflecting the transmitted packets back to the source host, or in recoding the reception times of the transmitted packets, for example. For example, pre-activation of components applied to a destination host or network device on a network path between the source host and the destination host can include pre-activating components used for receiving, processing or retransmitting packets, or for receiving, creating, processing or transmitting other messages related to network operations or the like.

In one embodiment, component warming comprises the transfer of the one or more sequences of packets to be transmitted into a cache memory which is most easily accessed by the central processing unit of the computing device associated with the test packet sequencer. In this manner, delays associated with the rate of access to the required information can be mitigated thereby reducing inherent delays that may occur at the source host. In one embodiment, the one or more sequences of packets are transferred from memory into an L1, Level 1 or primary cache, thereby speeding the central processing unit's access to the one or more sequences of packets for transmission.

In one embodiment, component warming comprises the transfer of the one or more instructions to be used for the transmission of the one or more sequences of packets into cache memory, wherein examples of the one or more instructions can include routines used to send and time stamp the one or more sequences of packets. In this manner, delays associated with the rate of access to the required instructions can be mitigated thereby reducing inherent delays that may occur at the source host. In one embodiment, the one or more instructions are transferred from memory into an L1, Level 1 or primary cache, thereby speeding the central processing unit's access to the one or more instructions.

In another embodiment of the invention, component warming includes the accessing of the one or more buffer memories associated with the NIC of the source host, thereby ensuring that this network interface is alert and ready for subsequent placement of the one or more sequences of packets onto the communication network.

In another embodiment of the invention, component warming includes the calling or pre-activation of the timing component, for example a timing routine or timing circuitry, associated with the test packet sequencer. For example the timing component can be called one or more times prior to the functional requirement of time-stamping of the one or more sequences of packets.

In another embodiment, component warming or other pre-activation action may be accomplished by performing an action, wherein the primary result of this action may not be the specific pre-activation action. In this embodiment, the specific pre-activation action can be an indirect response to the action, or may be a desired or intended additional response to the action performed. For example, component warming may be accomplished by establishing a TCP connection and sending commands via other known protocols like SNMP, or otherwise invoking an intended state by means that were not specifically designed to achieve said state. This format of a pre-activation action may be applied to a device or interface on the network path that offers access via an appropriate opportunistic mechanism, for example.

In one embodiment, component warming or pre-activation can include accessing one or more components on the destination host or a node or data link or other network device on the network path between the source host and the destination host. Accessing the components can be performed by direct action, for example by direct control of the associated device, or indirect action, for example by performing another action such as transmitting packets, messages, or instructions to the device having the components. For example, a cache memory holding instructions or packets, network interface buffer memory, CPU, timing or timestamp device, memory allocation module or other component of the destination host, node or data link or other network device on the network path can be warmed or pre-activated in this manner, thereby placing the component in a more desired or predictable state for handling the one or more sequences of packets.

### Cache/Buffer Optimization

At the source host, the operating system associated therewith may have a varying overhead requirement depending on the amount of data that is to be transmitted. For example, if the one or more sequences of packets are larger than the L1 cache can store, additional cache memory, for example the L2 cache, may be required in order to transmit the one or more sequences of packets. This lack of memory issue can likewise be an issue in relation to associated buffers for example the buffers associated with the NIC or other interfaces that are required for the transmission of the one or more sequences of packets by the test packet sequencer associated with the source host.

Therefore, in one embodiment of the invention, the pre-activation action includes the size modification of the one or more sequences of packets in order that the critical bounds, for example storage limits associated with the desired cache memory and buffers associated with the source host which are required for packet transmission, are satisfied, thereby reducing the delays associated with data access during the transmission of the one or more sequences of packets. For example, in some instances buffers may be re-configured, however cache memory like the L1 cache is fixed, except for the changing of the hardware components associated with the L1 cache.

In another embodiment of the invention, the pre-activation action includes the size modification of the one or more sequences of packets such that the amount of data associated therewith is configured in order to limit boundary effects associated with the cache or buffers. A boundary effect may introduce undesired clock cycles to the actions required for the transmission of the one or more sequences of packets.

In another embodiment, similar accommodation of the packet size associated with the one or more sequences of packets may be undertaken to optimize the response of the destination host, or other device on the network path, wherein the appropriate packet size may be detected by indirect means such as sending a variety of sequences of packets with different packet sizes to determine how various devices respond as a function of packet size, thereby selecting from the responses an optimal packet size associated with the one or more sequences of packets. Other indirect means of determining the appropriate packet size associated with the one or more sequences of packets may also be used.

### Linked Lists

In one embodiment of the invention, a pre-activation action includes the configuration of the actions required for the generation, transmission and time-stamping of the one or more sequences of packets as linked lists, rather than for example standard C++ STL routines. This use of linked lists may enable the reduction of the transmit or receive times associated with the one or sequences of packets.

### SpeedStep™

On some CPU chips, in particular those made by Intel™ for portable computers, Speedstep™ Technology is built-in. As is known, Speedstep™ technology is useful for conserving power when portable computers are running on batteries as this technology changes the processor frequency. If for example, the processor frequency changes at any time during the for example transmission, departure time-stamping, travel time or receipt time-stamping, the associated accuracy of the time-stamping will not be consistent as these actions were not performed at the same clock frequency of the central processing unit.

In one embodiment of the invention, a pre-activation action comprises the deactivation of the Speedstep™ Technology or similar technology associated with the one or more central processing units of the source host thereby eliminating this timing accuracy problem.

In another embodiment of the invention, the source host in particular is selected such that the one or more central processing units associated therewith do not have a technology similar to the Speedstep™ Technology.

In another embodiment, the behaviour of the Speedstep™ Technology or similar technology is monitored to determine how it is operating, such that the actions of transmission and reception of the one or more sequences of packets may be modified, or such that the timings recorded are analyzed appropriately. For example, the timings associated with the one or more sequences of packets transmitted during period of reduced frequency may be analyzed with respect to the observed frequency, or may be discarded entirely.

### Flow Control

As is known, during times of heavy network activity, a NIC's buffers can receive too much traffic and can fill up faster than the NIC can send the information. Therefore in cases like this, the NIC can transmit a wait command in order that data in its buffer can be sent before more data is forwarded to it. This intervention is called flow control.

In one embodiment of the invention, a pre-activation action includes the disabling of flow control associated with the NIC of the source host.

The invention will now be described with reference to specific examples. It will be understood that the following examples are intended to describe embodiments of the invention and are not intended to limit the invention in any way.

### EXAMPLE

According to one embodiment of the invention, a test packet sequencer is configured to be implemented using a Microsoft™ Windows™ operating system, for example Windows™ 2000™/XP™/Vista™/2003 Server. The test packet sequencer is configured to generate one or more sequences of packets and subsequently place these one or more sequences of packets onto a communication network. The test packet sequencer is further configured to at least measure the departure times of the one or more sequences of packets and in some embodiments the same test packet sequencer is further configured to measure receipt times of one or more sequences of packets, which depends on the nature of the network path being probed, for example an open loop or a closed loop.

In addition, the test packet sequencer is configured to perform the following pre-activation actions, wherein each are performed on at least a portion of the network path prior to placement of the one or more sequences of packets on the communication network.

In particular, immediately prior to the transmission of the one or more sequences of packets by the test packet sequencer associated with the source host, the test packet sequencer accesses all buffers of the source host which are used for the transmission of the test packets. For example, the one or more sequences of test packets are placed in the L1 cache immediately prior to transmission thereof.

In addition, the test packet sequencer executes the timer routine twice immediately prior to the transmission of the one or more sequences of packets. The timer routine is used for the time-stamping of the one or more sequences of packets and can be the routine QueryPerformanceCounter( ) as provided by the operating system Microsoft™ Windows™, for example.

Furthermore, a 64 byte primer packet is transmitted before each sequence of packets, for example before each burst or each datagram. For example, when a transmission command includes the transmission of multiple datagrams, for example 3 datagrams, a 64 byte primer packet is transmitted prior to each of these datagrams.

Finally, the test packet sequencer is configured to retain the timing measurements for the one or more sequences of packets regardless of whether the primer packet associated with a particular sequence of packets has been confirmed as received by the source host if the network path is configured as a closed path.

In one embodiment of the invention, the test packet sequencer uses I/O completion ports for sending and receiving the one or more sequences of packets. Each I/O completion port comprises an operating system kernel object which can handle multiple concurrent I/O requests. The I/O completion port can function in user mode or kernel mode in between the application, namely software associated with the test packet sequencer, and network protocol layers. Each I/O completion port may be associated with one or more sockets whose data transfer is to be handled and one or more threads to which execution control should be passed for processing notifications about completed I/O requests. I/O completion ports can allow other threads to pass explicit application level notifications with attached data to the thread(s) associated with the I/O completion port.

Each I/O completion port can internally and asynchronously queue I/O requests coming from user threads. When the I/O completion port switches to kernel mode it executes the queued requests. Since I/O completion ports execute the queued I/O requests while operating in kernel mode, the execution of the requests can suffer reduced interruptions. The requests can thus be executed quickly because I/O completion ports typically have faster access to protocol drivers than do the user threads associated with the test packet sequencer software. This can allow the outgoing one or more sequences of packets to be very closely spaced. Similarly, it can allow the timing of incoming one or more sequences of packets to be more accurately recorded.

When an I/O completion port completes an I/O request it notifies a first available one of the thread(s) associated with the I/O completion port and passes execution control to the thread. This allows the thread to process the completed request. The thread may obtain a time stamp for the completed request among other processing functions.

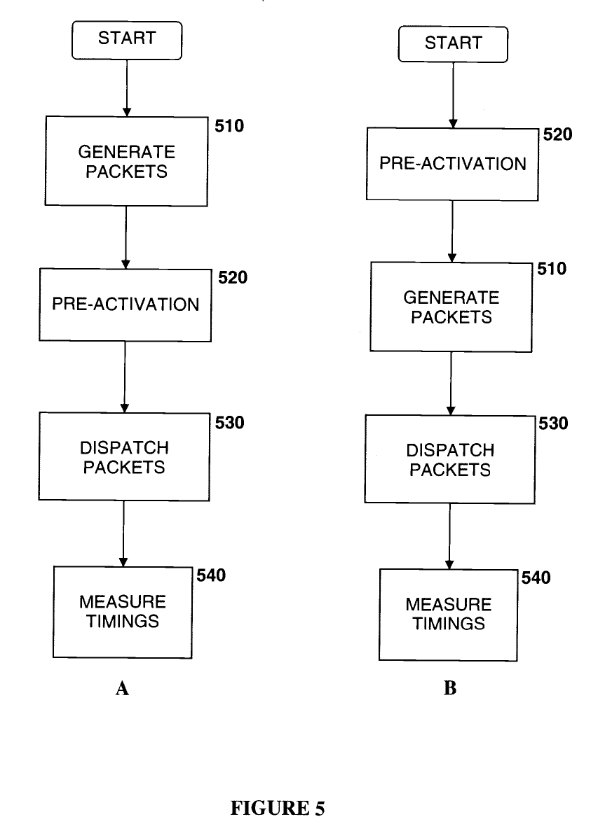

FIG. 5A illustrates a method for probing a portion of a communication network according to embodiments of the present invention. According to the illustrated method, one or more sequences of packets are generated for dispatching onto the communication network in step 510. The one or more sequences of packets can be configured with respect to one or more various aspects, for example with respect to packet sizes, packet protocols, time-to-live counts, inter-packet spacings, burst timings, or other aspects as described above or as would be understood by a worker skilled in the art. In some embodiments, generation of the one or more sequences of packets is configured to test or measure one or more predetermined aspects of the network. Also according to the illustrated method, a pre-activation action is performed in a step 520. For example, performing the pre-activation action can include dispatching one or more primer packets onto the communication network, accessing or “warming” one or more component devices in a source, destination or intermediate network device, performing another action whose consequence is a pre-activation action, or a combination of the above. In some embodiments, the pre-activation action in step 520 can include one or more sub-actions, and/or the pre-activation action in step 520 can include actions at different locations in the communication network. Although step 520 appears to follow step 510 in FIG. 5A, the pre-activation action in step 520 can be initiated before, during, or after step 510 in embodiments of the method. After initiation of step of 520, the one or more sequences of packets generated in step 510 can be dispatched onto the communication network. In some embodiments, dispatching of packets is dependent upon observations related to the pre-activation action. For example, if the communication network response to the pre-activation action indicates a level of latency in the network, a delay before dispatching of the one or more sequences of packets can be introduced or adjusted to account for the indicated level of latency.

FIG. 5B illustrates a method for probing a portion of a communication network according to another embodiment of the present invention. FIG. 5B includes the same steps 510 (packet generation), 520 (pre-activation), 530 (dispatching packets) and 540 (measuring timings) as FIG. 5A. However, in the present embodiment, step 510 is made explicitly dependent on step 520. While it is again not necessary for step 520 to be completed before performing all of step 510, this embodiment explicitly allows for at least a portion of step 510 to be dependent on step 520. For example, network response to the pre-activation action may be used to configure packet generation parameters, such as size, protocol, timing, route, time-to-live, and the like in order to make testing of the network dependent on initial responses to the one or more pre-activation actions. For example, limiting mechanisms can be activated or avoided, portions of buffer memory can be accesses or avoided, or multi-channel paths can be pre-loaded in this manner. In one embodiment, dispatching of packets in step 530 can also be at least partially dependent on step 520, as described with respect to the embodiment of FIG. 5A.

Continuing with respect to the embodiments of FIGS. 5A and 5B, according to the illustrated methods timings are measured in step 540. Timing information can pertain to the transmission of the one or more sequences of packets by a source network device, reception of packets at an intermediate or destination network device, receipt of acknowledgements, lack of receipt of packets or acknowledgements, or other information regarding the flow of the one or more sequences of packets through the network. Timing information can be gathered during or after dispatching of the one or more sequences of packets in step 530. Measurements based on timing information can be carried out in several ways to measure for example latency, capacity, device behaviours, network routing behaviours, or other behaviours as would be understood by a worker skilled in the art. Timing information can also be associated with the pre-activation step 520. For example, timing information for primer packets can be used to validate timing measurements for the one or more sequences of packets.

### Variations

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a magnetic or optical wire, tape or disc, or the like, for storing signals readable by a machine, for controlling the operation of a computer according to the method of the invention and/or to structure its components in accordance with the system of the invention.

In addition, while the above discusses the invention as it can be implemented using a generic OS and/or generic hardware, it is within the scope of the present invention that the method, apparatus and computer program product of the invention can equally be implemented to operate using a non-generic OS and/or can use non-generic hardware.

Further, each step of the method may be executed on any general computer, such as a personal computer, server or the like and pursuant to one or more, or a part of one or more, program elements, modules or objects generated from any programming language, such as C++, Java, Pl/1, or the like. In addition, each step, or a file or object or the like implementing each said step, may be executed by special purpose hardware or a circuit module designed for that purpose.

All such modifications as would be readily apparent to one skilled in the art are intended to be included within the scope of the following claims.

We claim:

1. A method for probing at least a portion of a communication network, the method comprising:
a) generating one or more sequences of packets;
b) performing a pre-activation action on at least a portion of a network path defined within the communication network;
c) dispatching the one or more sequences of packets onto the communication network, the one or more sequences of packets configured to travel along at least a portion of the network path; and
d) measuring timings associated with the one or more sequences of packets.

2. The method according to claim 1, wherein the pre-activation action includes dispatching one or more primer packets onto the communication network such that the one or more primer packets are independent of the one or more sequences of packets and wherein the one or more primer packets are configured to travel along at least a portion of the network path.

3. The method according to claim 2, wherein a predetermined separation of time is provided between dispatching of a last of the one or more primer packets and dispatching of a first packet of the one or more sequences of packets.

4. The method according to claim 2, wherein the predetermined separation is between about 1 millisecond and about 10 milliseconds.

5. The method according to claim 2, wherein one or more of the primer packets are configured using a protocol selected from the group comprising ICMP, UDP, TCP and RTP, and wherein one or more of the sequences of packets are configured using a protocol selected from the group comprising ICMP, UDP, TCP and RTP.

6. The method according to claim 2, wherein one or more of the primer packets are configured having a size between about 46 bytes and about 1500 bytes.

7. The method according to claim 2, wherein one or more of the primer packets have a first size and one or more packets of the sequence of packets have a second size, wherein the first size and the second size are about equal.

8. The method according to claim 2, wherein one or more of the primer packets are configured with a time to live count, the time to live count determined to cause the one or more of the primer packets to be discarded at a predetermined location along the network path.

9. The method according to claim 2, further comprising measuring timings associated with the one or more primer packets, wherein the measured timings associated with the one or more primer packets are used to validate the measured timings associated with the one or more sequences of packets.

10. The method according to claim 1, wherein the pre-activation action is configured to identify one or more attributes indicative of behaviour along at least a portion of the network path, and wherein dispatching the one or more sequences of packets is configured based on said one or more attributes.

11. The method according to claim 10, wherein one or more of the attributes is indicative of one or more of: state of limiting mechanisms, state of device readiness, packet sizes supported, state of multi-channel paths, state of anti-DDOS mechanisms, state of buffer memory levels, presence of Speedstep™ technology and state of flow control mechanisms.

12. The method according to claim 1, wherein the one or more sequences of packets are dispatched from a source host, and wherein the pre-activation action includes accessing one or more component devices operatively coupled to the source host.

13. The method according to claim 12, wherein the pre-activation action includes transferring at least a portion of the one or more sequences of packets into a cache memory operatively coupled to the source host.

14. The method according to claim 12, wherein the pre-activation action includes transferring computer instructions into a cache memory operatively coupled to the source host, said computer instructions including instructions for dispatching of the one or more sequences of packets onto the communication network.

15. The method according to claim 12, wherein the pre-activation action includes accessing a network interface buffer memory operatively coupled to the source host, the network interface buffer memory configured to hold at least a portion of the one or more sequence of packets during dispatching thereof.

16. The method according to claim 12, wherein the pre-activation action includes accessing one or more component devices associated with a timing module operatively coupled to the source host, the timing module configured for time-stamping of the one or more sequences of packets dispatched thereby.

17. The method according to claim 1, wherein the pre-activation action includes accessing one or more component devices associated with one or more network devices along the network path or at a destination host of said network path.

18. The method according to claim 17, wherein the one or more component devices are selected from the group comprising cache memory providing instructions, cache memory providing data, network interface buffer memory and time stamping component devices.

19. The method according to claim 1, further comprising:
e) generating a second one or more sequences of test packets based on the measured timings associated with the one or more sequences of packets;
f) performing a second pre-activation action on at least a portion of a network path defined within the communication network, the second pre-activation action based on the measured timings associated with the one or more sequences of packets;
g) dispatching the second one or more sequences of packets onto the communication network, the second one or more sequences of packets configured to travel along at least a portion of the network path, said dispatching based on the measured timings associated with the one or more sequences of packets; and
h) measuring timings associated with the second one or more sequences of packets.

20. An apparatus for probing at least a portion of a communication network, the apparatus comprising:
e) means for generating one or more sequences of packets;
f) means for performing a pre-activation action on at least a portion of a network path defined within the communication network;
g) means for dispatching the one or more sequences of packets onto the communication network, the one or more sequences of packets configured to travel along at least a portion of the network path; and
h) means for measuring timings associated with the one or more sequences of packets.

21. The apparatus according to claim 20, wherein the pre-activation action includes dispatching one or more primer packets onto the communication network such that the one or more primer packets are independent of the one or more sequences of packets and wherein the one or more primer packets are configured to travel along at least a portion of the network path.

22. The apparatus according to claim 21, wherein a predetermined separation of time is provided between dispatching of a last of the one or more primer packets and dispatching of a first packet of the one or more sequences of packets.

23. The apparatus according to claim 21, wherein the predetermined separation is between about 1 millisecond and about 10 milliseconds.

24. The apparatus according to claim 21, wherein one or more of the primer packets are configured using a protocol selected from the group comprising ICMP, UDP, TCP and RTP, and wherein one or more of the sequences of packets are configured using a protocol selected from the group comprising ICMP, UDP, TCP and RTP.

25. The apparatus according to claim 21, wherein one or more of the primer packets are configured having a size between about 46 bytes and about 1500 bytes.

26. The apparatus according to claim 21, wherein one or more of the primer packets have a first size and one or more packets of the sequence of packets have a second size, wherein the first size and the second size are about equal.

27. The apparatus according to claim 21, wherein one or more of the primer packets are configured with a time to live count, the time to live count determined to cause the one or more of the primer packets to be discarded at a predetermined location along the network path.

28. The apparatus according to claim 21, further comprising measuring timings associated with the one or more primer packets, wherein the measured timings associated with the one or more primer packets are used to validate the measured timings associated with the one or more sequences of packets.

29. The apparatus according to claim 20, wherein the pre-activation action is configured to identify one or more attributes indicative of behaviour along at least a portion of the network path, and wherein dispatching the one or more sequences of packets is configured based on said one or more attributes.

30. The apparatus according to claim 29, wherein one or more of the attributes is indicative of one or more of: state of limiting mechanisms, state of device readiness, packet sizes supported, state of multi-channel paths, state of anti-DDOS mechanisms, state of buffer memory levels, presence of Speedstep™ technology and state of flow control mechanisms.

31. The apparatus according to claim 20, wherein the means for dispatching the one or more sequences of packets includes a source host, and wherein the pre-activation action includes accessing one or more component devices operatively coupled to the source host.

32. The apparatus according to claim 31, wherein the pre-activation action includes transferring at least a portion of the one or more sequences of packets into a cache memory operatively coupled to the source host.

33. The apparatus according to claim 31, wherein the pre-activation action includes transferring computer instructions into a cache memory operatively coupled to the source host, said computer instructions including instructions for dispatching of the one or more sequences of packets onto the communication network.

34. The apparatus according to claim 31, wherein the pre-activation action includes accessing a network interface buffer memory operatively coupled to the source host, the network interface buffer memory configured to hold at least a portion of the one or more sequence of packets during dispatching thereof.

35. The apparatus according to claim 31, wherein the pre-activation action includes accessing one or more component devices associated with a timing module operatively coupled to the source host, the timing module configured for time-stamping of the one or more sequences of packets dispatched thereby.

36. The apparatus according to claim 20, wherein the pre-activation action includes accessing one or more component devices associated with one or more network devices along the network path or at a destination host of said network path.

37. The apparatus according to claim 36, wherein the one or more component devices are selected from the group comprising cache memory providing instructions, cache memory providing data, network interface buffer memory and time stamping component devices.

38. An apparatus for probing at least a portion of a communication network, the apparatus comprising:
i) a computer processor;
j) a network interface operatively coupled to the computer processor;
k) a memory accessible by the computer processor, the memory comprising test packet sequencer software comprising a series of instructions executable by the computer processor under control of an operating system, the instructions, if executed by the computer processor, causing the computer processor to:
i) generate one or more sequences of packets;
ii) perform a pre-activation action on at least a portion of a network path defined within the communication network;
iii) dispatch the one or more sequences of packets onto the communication network using the network interface, the one or more sequences of packets configured to travel along at least a portion of the network path; and
iv) measure timings associated with the one or more sequences of packets.

39. The apparatus according to claim 38, wherein the pre-activation action includes dispatching one or more primer packets onto the communication network such that the one or more primer packets are independent of the one or more sequences of packets and wherein the one or more primer packets are configured to travel along at least a portion of the network path.

40. The apparatus according to claim 39, wherein a predetermined separation of time is provided between dispatching of a last of the one or more primer packets and dispatching of a first packet of the one or more sequences of packets.

41. The apparatus according to claim 39, wherein the predetermined separation is between about 1 millisecond and about 10 milliseconds.

42. The apparatus according to claim 38, wherein the pre-activation action includes creating one or more threads, the threads associated with execution of instructions on the computer processor.

43. The apparatus according to claim 38, wherein dispatching of the one or more sequences of packets is performed using linked lists, wherein performing the pre-activation action includes actions related to preparing said linked lists.

44. The apparatus according to claim 38, wherein configuration of the apparatus is substantially independent of an operating system for operation thereof.

45. The apparatus according to claim 38, wherein the apparatus is operable on generic hardware.

46. A computer program product comprising a computer readable medium having a computer program recorded thereon which, when executed by a computer processor, cause the processor to execute a method for probing at least a portion of a communication network, said method comprising the steps of:
l) generating one or more sequences of packets;
m) performing a pre-activation action on at least a portion of a network path defined within the communication network;
n) dispatching the one or more sequences of packets onto the communication network, the one or more sequences of packets configured to travel along at least a portion of the network path; and
o) measuring timings associated with the one or more sequences of packets.

47. The computer program product according to claim 46, wherein the pre-activation action includes dispatching one or more primer packets onto the communication network such that the one or more primer packets are independent of the one or more sequences of packets and wherein the one or more primer packets are configured to travel along at least a portion of the network path.

48. The computer program product according to claim 46, wherein a predetermined separation of time is provided between dispatching of a last of the one or more primer packets and dispatching of a first packet of the one or more sequences of packets.
